(19) United States
(12) Patent Application Publication
(10) Pub. No.: US 2017/0126293 A1
(43) Pub. Date: May 4, 2017

(54) IMPROVED SIGNALLING FIELD IN UPLINK MU-MIMO

(71) Applicants: Xiaogang CHEN, Beijing (CN); Eldad Perahia, Portland, OR (US); Honggang Li, Beijing (CN); Qinghua Li, San Ramon, CA (US); Thomas J. Kenney, Portland, OR (US)

(72) Inventors: Xiaogang CHEN, Beijing (CN); Eldad Perahia, Portland, OR (US); Honggang Li, Beijing (CN); Qinghua Li, San Ramon, CA (US); Thomas J. Kenney, Portland, OR (US)

(21) Appl. No.: 15/121,263

(22) PCT Filed: Mar. 28, 2014
(86) PCT No.: PCT/CN2014/074237

§ 371 Date: Aug. 24, 2016

(51) Int. Cl. H04B 7/0452; H04B 7/0404

(52) U.S. Cl. CPC H04B 7/0452; H04B 7/0404; H04W 80/02

(57) ABSTRACT

Disclosed in some examples are devices (e.g., APs, STAs, and the like), methods, and machine readable mediums which provide for proper channel estimation and frame reception in Uplink MU-MIMO systems by changing the way transmission parameters from the VHT-SIG-A are communicated to the recipients in the preamble. The transmission parameters contained in the VHT-SIG-A field may be communicated to the STAs in advance of the MU-MIMO transmissions. In other examples the transmission parameters contained in the VHT-SIG-A field may be moved to locations in the preamble that come after the VHT-STF and VHT-LTF so that the transmission parameters may be decoded.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Intel Inc., All Rights Reserved.

### TECHNICAL FIELD

Embodiments pertain to wireless networks such as Wireless LANS (WLANs). Some embodiments relate to signaling fields in WLAN frames. Some additional embodiments relate particularly to signaling fields in WLAN frames for use in uplink multiple user multiple input multiple output (MU-MIMO) systems.

### BACKGROUND

Multiple Input Multiple Output (MIMO) systems leverage the phenomenon known as multipath in order to increase the amount of data that can be sent at the same time and on the same frequency. In some examples, this increase in data is dedicated to one client, increasing the effective bandwidth for that client by the number of spatial streams. In some examples, multiple clients may be served simultaneously by transmitting or receiving from these multiple clients at the same time and frequency but utilizing different spatial streams for each client. Utilizing MIMO to serve multiple clients is termed MU-MIMO, or Multiple User MIMO. MU-MIMO may be implemented in the downlink (e.g., from the access point (AP) to wireless stations (STAs)) or the uplink (e.g., from the wireless STAs to the access points (AP)).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example 802.11ac preamble used for downlink MU-MIMO.

FIG. 2 shows a flowchart of a method of exchanging transmission parameters utilizing higher layer signaling according to some examples of the present disclosure.

FIG. 3 shows a flowchart of a method of sending an UL-MU-MIMO packet according to some examples of the present disclosure.

FIG. 4 shows a flowchart of a method of sending an UL-MU-MIMO transmission according to some examples of the present disclosure.

FIG. 5 shows a flowchart of a method of receiving an UL-MU-MIMO transmission according to some examples of the present disclosure.

FIG. 6 shows a logical schematic of an AP and a STA according to some examples of the present disclosure.

FIG. 7 is a block diagram illustrating an example of a machine upon which one or more embodiments may be implemented.

### DETAILED DESCRIPTION

The Institute for Electrical and Electronics Engineers (IEEE) has promulgated the 802.11 family of standards which specify requirements for compatible Wireless Local Area Networks (WLANs). MIMO support for 802.11 networks was introduced in 802.11n and downlink MU-MIMO was introduced in 802.11ac. 802.11 networks do not currently support uplink MU-MIMO. In 802.11 networks, a preamble is added by the sender to transmissions over the wireless medium. This preamble is utilized by the receiver to allow the receiver to detect the transmission (called a packet or frame), estimate various channel properties, get information about the modulation and coding schemes of the transmission and get information on the payload of the frame.

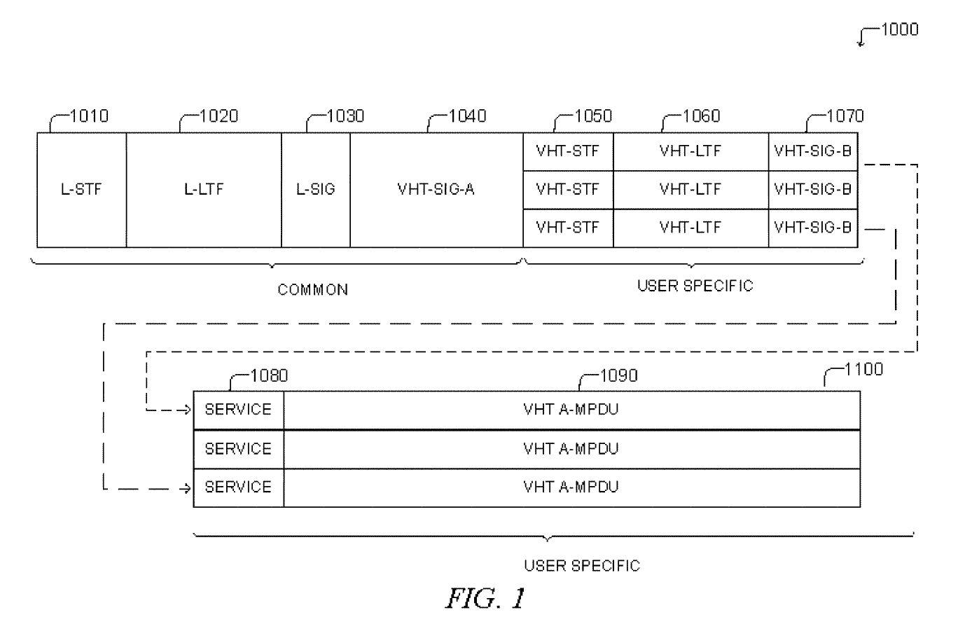

FIG. 1 shows an example 802.1 lac physical layer convergence protocol data unit (PPDU) including preamble used for downlink MU-MIMO. A Legacy Short Training Field (L-STF 1010), a Legacy Long Training Field (L-LTF 1020), and a Legacy Signal Field (L-SIG) 1030 are used by legacy devices that support older versions of 802.11 (e.g., pre-802.11n) to allow those devices to share the network with newer devices. These fields allow the legacy devices (e.g., such as devices supporting 802.11g) on the network to detect a packet, determine that the packet is not addressed to them, and to set their network allocation vectors (NAV) so that they do not transmit any interfering frames during the time the received frame occupies the wireless media.

The Very High Throughput (VHT) fields are modulated next. VHT SIGNAL A (VHT-SIG-A) 1040 includes transmission parameters that allow the receiver to decode the rest of the packet. These transmission parameters may be divided into STA specific parameters which are specific to a particular STA and common transmission parameters that are common for all receiving STA. The L-STF, L-LTF, L-SIG, and VHT-SIG-A (1010-1040) are sent to all of the downlink users. That is, those portions of the frames are not beamformed.

The rest of the frame is beamformed to the individual recipient STAs. FIG. 1 shows beamforming to three different STAs, each receiving potentially different data in fields 1050-1100. The VHT Short Training Field (VHT-STF) allow for accurate power estimates for automatic gain control and other parameter estimations between each individual user STA and the access point (AP). The VHT Long Training Field (VHT-LTF) allows for MIMO channel estimation. The VHT-SIG-B may indicate the length of the useful data in the packet to allow a user to shut-off the receiver to save power after the useful data has been received. This may be useful in the MU-MIMO setting where length fields in earlier portions of the preamble report the total length (including the padding and tail bits) and where the amount of padding and/or tail for a particular user is large.

This preamble structure is designed for downlink (DL) MU-MIMO and as currently constructed, does not work for uplink MU-MIMO. In the downlink, the AP (single sender) sends a single frame to all STAs (multiple receivers). In the uplink, multiple STAs are transmitting (multiple senders) to the same recipient AP (single receiver). The first issue with using this preamble format for UL MU-MIMO is that because multiple stations are transmitting their VHT-STF and VHT-LTF at the same time and on the same frequency resources the AP has no way of separating the signals from each other and performing the required estimations. Since the currently defined VHT-STF and VHT-LTF cannot be decoded properly in the UL MU-MIMO case, the individual MU-MIMO spatial streams cannot be estimated and the subsequent packets cannot be decoded.

In some examples, to solve this issue, each STA's VHT-STF and VHT-LTF may be time multiplexed according to an allocation specified by the AP, or frequency multiplexed according to an allocation specified by the AP.

The second issue with the current preamble is that even if the AP could discriminate between each STA's VHT-STF and VHT-LTF and use that to estimate the channel, because the VHT-SIG-A comes before the VHT-STF and VHT-LTF, the AP cannot yet decode separate spatial streams from the STAs. The VHT-SIG-A contains both STA specific transmission parameters and transmission parameters common to all STA that are necessary to decode the rest of the frame. If the VHT-SIG-A was sent by each device simultaneously on different spatial streams, the AP would fail to decode the VHT-SIG-A since each user would have potentially different values in the different bit positions where the data is not common (e.g., NSTS, Coding MCS, and the like). This would cause interference at those bit instances at the AP, and because of the channel coding applied it is likely that the AP would not be able to successfully decode any of the VHT-SIG-A. The AP may be able to successfully decode the VHT-SIG-A if the STA specific transmission parameters were not included by the STAs in the VHT-SIG-A (i.e., the VHT-SIG-A communicated only the common parameters) as then the VHT-SIG-A sent by all STA would then be identical and would not interfere with each other at the AP.

As can be appreciated from the foregoing discussion, the current 802.11ac VHT-SIG-A does not support the uplink MU-MIMO case and there is a need for a new way to reliably convey that information to the AP from each STA. Disclosed in some examples are devices (e.g., APs, STAs, and the like), methods, and machine readable mediums which provide for proper channel estimation and frame reception in Uplink MU-MIMO systems by changing the way transmission parameters from the VHT-SIG-A are communicated to the recipient STAs. The transmission parameters (e.g., the STA specific transmission parameters, the common transmission parameters, or both) contained in the VHT-SIG-A field may be pre communicated to the STAs in advance of the MU-MIMO transmissions (e.g., such as by using prior Medium Access Control (MAC) signaling). The parameters that are pre communicated from the AP to the STA may be excluded from the VHT-SIG-A field in the STAs uplink MU-MIMO transmissions. Thus, the VHT-SIG-A field may contain only the common transmission properties, which may allow the AP to properly decode it (as all stations are sending the same VHT-SIG-A field), or may be omitted altogether in the case where both common and STA specific transmission properties are pre communicated. In still other examples, rather than pre communicate the transmission parameters, the STA specific transmission parameters contained in the VHT-SIG-A field may be moved to locations in the VHT-SIG-B that come after elements of the preamble that allow the AP to estimate the channel (e.g., the VHT-STF and VHT-LTF) so that the transmission parameters may be decoded.

In the first examples, the AP may control UL MU-MIMO transmission parameters (e.g., the STA specific transmission parameters, the common transmission parameters, or both) of each STA participating in the UL MU-MIMO transmission and communicate these parameters to the STAs in advance. In the case where the STA specific transmission parameters (but not the common transmission parameters) are communicated in advance, because the AP already knows the STA specific transmission parameters, the AP may ignore the STA specific parameters in the VHT-SIG-A field and decode only the common transmission parameters. In the case where both the STA specific transmission parameters and the common transmission parameters are communicated in advance, the VHT-SIG-A field may be omitted.

In some examples, the transmission parameters may be communicated by using a protocol that is higher than a physical protocol layer. Protocols may include a Medium Access Control (MAC) protocol, a Logical Link Control layer (LLC), and the like. For example, these parameters may be setup during an UL-MU-MIMO initialization process utilizing MAC management frames.

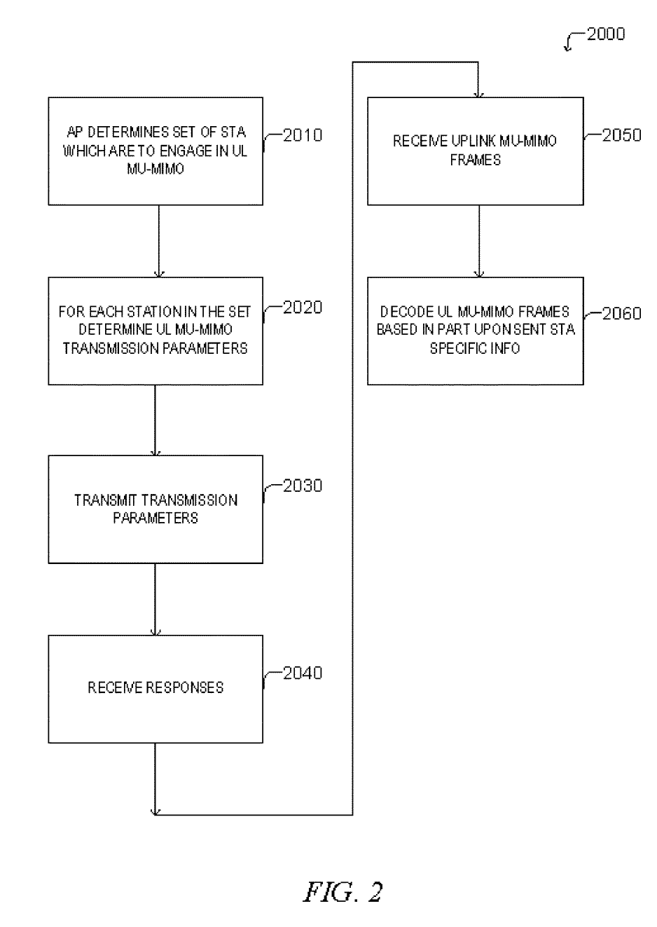

FIG. 2 shows a flowchart of a method 2000 of exchanging transmission parameters utilizing higher layer signaling according to some examples of the present disclosure. At operation 2010, the AP may determine the set of STA that are to engage in the same MU-UL-MIMO transmission. This may be determined based upon indications from STAs that they have data available to send to the AP. In other examples, the set of STA may be all STA associated with the AP. In yet other examples, other groups of STA may be determined based upon other factors. At operation 2020, the MU UL-MIMO transmission parameters may be determined, including the STA specific parameters for each STA in the set. In some examples, the transmission parameters determined at operation 2020 may include common transmission parameters which are not specific to a particular station. At operation 2030 the transmission parameters may be transmitted to each station. The transmission parameters transmitted may include the STA specific transmission parameters, the common transmission parameters, or both. In some examples, this transmission may be a broadcast transmission to all STA in the set. In yet other examples this may be a multicast transmission to the nodes in the set. In still additional examples, this may be transmitted via a series of unicast transmissions to STAs in the set. In some examples, a protocol layer that is above a physical layer in the 802.11 protocol stack may be utilized to send the transmission parameters. Example layers may include the Medium Access Control (MAC) layer, the Logical Link Control (LLC) layer or the like. The transmission parameters may be sent in a new protocol message for the purpose of sending the transmission parameters, or may be included in other messages (e.g., MAC management messages, other frames carrying user data, or the like.) At operation 2040, the STA may respond to the AP. In some examples this response may be a simple acknowledgement (ACK) packet. In other examples, the response may propose modified transmission parameters, in other examples, the STA may not respond to the AP. If the response includes modified transmission parameters, the AP may approve or reject the modifications. Any transmission parameter modifications to one STA may require sending modifications to other STA in the set.

At operation 2050 UL-MU-MIMO frames may be received. Those frames may then be decoded at operation 2060. The frames may be decoded using the transmission parameters previously communicated to the STA. For example, the AP may skip decoding the VHT-SIG-A if both the common and STA-specific transmission parameters were pre-communicated by the AP. If only the STA-specific transmission parameters were pre-communicated, then the AP may decode only the common portions of the VHT-SIG-A field. Next, the VHT-STF and VHT-LIT may be utilized to estimate the channel parameters between the AP and one of the STA utilizing UL MU-MIMO. Once the VHT-STF and VHT-LTF are decoded, the rest of the packet including the VHT-SIG-B and the PPDU may be decoded using the transmission parameters.

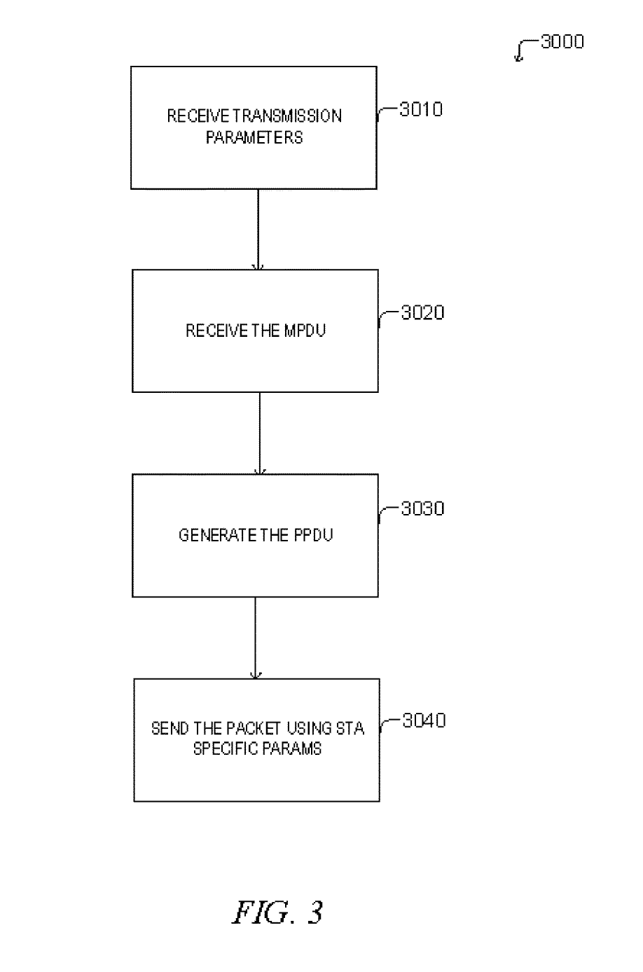

FIG. 3 shows a flowchart of a method 3000 of sending an UL-MU-MIMO packet according to some examples of the present disclosure. At operation 3010 the STA may receive transmission parameters from the AP. The transmission parameters may be STA specific transmission parameters, common transmission parameters, or both. These transmission parameters may be received utilizing a protocol message of a protocol that is of a higher layer than a physical layer (e.g., MAC layer). The parameters may be received via a broadcast, multicast, or unicast message.

At operation 3020 the physical (PHY) layer receives one or more Medium Access Control Protocol Data Units (MPDU) from the MAC layer. At operation 3030 a Physical Layer Convergence Protocol Data Unit (PPDU) may be generated based upon the MPDUs and the transmission parameters. The PPDU may be an 802.11 compliant PPDU and may include any of the fields shown in FIG. 1. The fields of the VHT-SIG-A that were pre-communicated by the AP may not be filled in by the STA (e.g., the bits reserved for this information may be set to zero or some other value.) In these examples the AP may ignore these portions of the VHT-SIG-A (or the entire VHT-SIG-A). At operation 3040 the PPDU may be sent utilizing the transmission parameters (e.g., MCS, spatial stream info, and the like).

In some examples, by exchanging the transmission parameters of the VHT-SIG-A by utilizing higher layer signaling, the L-STF, L-LTF, L-SIG and VHT-SIG-A may not be sent at all. This is because the L-STF and L-LTF and L-SIG are used for automatic gain control, timing, frequency, and channel acquisition which are specific to a particular signal path. Since each uplink STA has a different path (and thus different path loss and timing/frequency offset), it doesn't add anything for each uplink STA to send the same L-STF, L-LTF, L-SIG and VHT-SIG-A. In some examples, because the L-STF, L-LTF and L-SIG are used to inform legacy devices that the medium is busy, the AP or one of the STAs may utilize a spoofing mechanism to inform legacy devices that the medium is busy. For example, one of the STA or the AP may send a legacy packet prior to the UL-MU-MIMO transmissions with a dummy or non-existent payload which contains parameters in the legacy headers which, when read by the legacy STAs, would cause those stations to set their Network Allocation Vectors (NAV) to a value which would preclude those devices from utilizing the medium during the UL-MU-MIMO transmission period.

Another possible solution to the problem of decoding transmission parameters of the VHT-SIG-A involves moving the transmission parameters (STA specific transmission parameters, common transmission parameters, or both) of the VHT-SIG-A to a different part of the preamble that is after the VHT-STF and VHT-LIT instead of sending the transmission parameters of the VHT-SIG-A using higher layer signaling. One example preamble field may include the VHT-SIG-B field, which is after the VHT-STF and VHT-LTF, and is therefore decodable on a per STA basis.

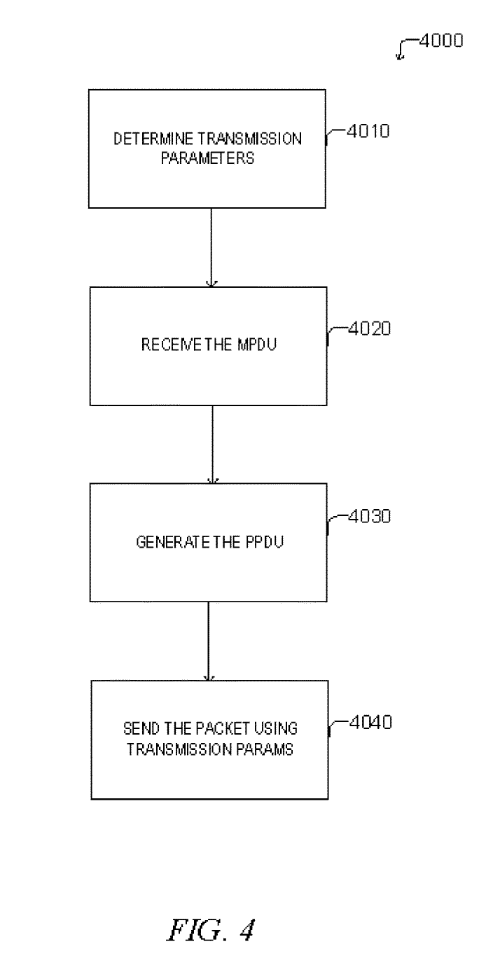

FIG. 4 shows a flowchart of a method 4000 of sending an UL-MU-MIMO transmission according to some examples of the present disclosure. At operation 4010 the transmission parameters for the transmission may be determined. In some examples, the STA may calculate the transmission parameters. In other examples the STA may receive the transmission parameters from the AP. In some examples, the transmission parameters may include one or both of the STA specific transmission parameters and the common transmission. At operation 4020 the MPDU from the MAC layer is received at the physical layer for transmission. It should be appreciated by one of ordinary skill in the art that in any of the flowcharts in this specification that multiple MPDUs may be received and aggregated into a PPDU. At operation 4030 the PPDU may be generated. In some examples, the VHT-SIG-A field of the generated PPDU may include only the common transmission parameters. The VHT-SIG-B field of the PPDU may contain the transmission parameters specific to a particular STA. In other examples the VHT-SIG-A field may not include any transmission parameters (e.g., the VHT-SIG-A field may not contain useful information) as the VHT-SIG-A parameters may be included in the VHT-SIG-B. In yet other examples, the VHT-SIG-A may be moved after the VHT-STF and VHT-LTF in the PPDU. At operation 4040 the PPDU may be sent utilizing the transmission parameters.

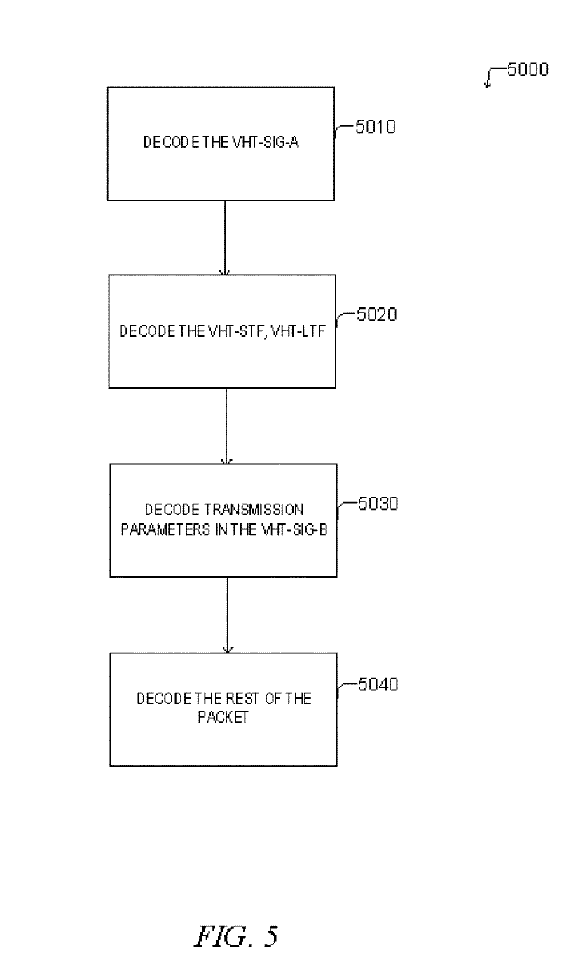

FIG. 5 shows a flowchart of a method 5000 of receiving an UL-MU-MIMO transmission according to some examples of the present disclosure. At operation 5010 the VHT-SIG-A may be decoded and transmission parameters common to all STA may be determined. In some examples, the AP may not decode the VHT-SIG-A as these transmission parameters may also be included in the VHT-SIG-B. At operation 5020 the VHT-STF and VHT-LTF may be utilized to estimate the channel parameters between the AP and one of the STA utilizing UL MU-MIMO. Once the VHT-STF and VHT-LTF are decoded, the transmission parameters that were once included in the VHT-SIG-A for DL MU-MIMO may be decoded from the VHT-SIG-B at operation 5030. In some examples, these parameters may include both STA specific and STA non-specific transmission parameters. At operation 5040 the rest of the packet may be decoded.

In some examples, the STA specific parameters may include one or more of: Group Id, Number of Space Time Streams (NSTS), MCS, length, and coding (which denotes BCC or LDPC).

In some examples, the transmission parameters that are not specific to a

STA may include one or more of: Bandwidth field, Space Time Block Codes (STBC) field, TXOP-PS_NOT_ALLOWED, SHORT GI, SHORT GI NSYM DISAMBIGUATION, LDPC EXTRA OFDM SYMBOL.

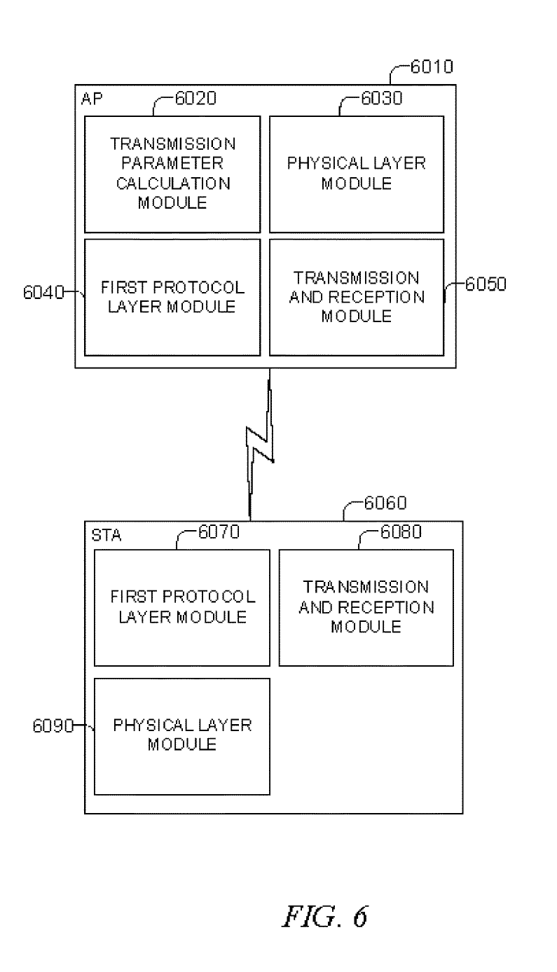

FIG. 6 shows a logical schematic of an AP 6010 and a STA 6060 according to some examples of the present disclosure. The modules shown in FIG. 6 may be implemented in any combination of hardware and software. For example, the modules may be implemented as one or more circuits. AP may include a transmission parameter calculation module 6020 which may calculate both common and STA specific transmission parameters. In some examples, the transmission parameter calculation module 6020 may calculate the transmission parameters based upon one or more measurements of the wireless medium between the AP and one or more STA. First Protocol Layer Module 6040 may be a module implementing a protocol layer above a physical protocol layer for an 802.11 wireless system (or another wireless system). In some examples, the first protocol layer module 6040 may package the transmission parameters calculated by the transmission parameter calculation module 6020 into a protocol message. For example, first protocol layer module 6040 may implement a MAC protocol layer and package the common transmission parameters, the STA specific transmission parameters, or both into a MAC layer message. In some examples, the first protocol layer module 6040 may transmit this message to one or more STA 6060 using transmission and reception module 6050 and physical layer module 6030.

Physical layer module 6030 may receive a MAC PDU and add preamble and other physical layer fields to create a PPDU. The PPDU may contain any one or more of the fields of FIG. 1. Physical layer module 6030 may then pass the PPDU to the transmission and reception module 6050 for transmission on the medium. Physical layer module 6030 may also receive and decode frames demodulated from transmission and reception module 6050 and extract the MAC PDU from the PPDU and pass the MAC PDU to the first protocol layer module 6040. Physical layer module 6030 may also be responsible for properly configuring the transmission and reception module 6050 to properly decode packets based upon information in the preamble of the packet or based upon the transmission parameters previously calculated. Transmission and reception module 6050 may modulate packets on the wireless medium sent from the AP 6010 and may demodulate packets sent to the AP 6010. In some examples the modulation and demodulation may be based upon the transmission parameters calculated by the transmission parameter calculation module 6020 or determined based upon information in the preamble of a packet as decoded by the physical layer module 6030.

STA 6060 may include a First Protocol Layer Module 6070 which may be a module implementing a protocol layer above a physical protocol layer for an 802.11 wireless system (or another wireless system). In some examples, the first protocol layer module 6070 may receive the transmission parameters from a protocol message sent by the first protocol layer module 6040 of the AP 6010. For example, first protocol layer module 6070 may implement a MAC protocol layer and receive common transmission parameters, STA specific transmission parameters, or both in a MAC layer message. In some examples, the first protocol layer module 6070 may receive this message via transmission and reception module 6080 and physical layer module 6090.

Physical layer module 6090 may receive a MAC PDU and add preamble and other physical layer fields to create a PPDU. The PPDU may contain any one or more of the fields of FIG. 1. Physical layer module 6090 may also receive and decode a frame from transmission and reception module and extract the MAC PDU from the PPDU and pass the MAC PDU to the first protocol layer module 6070. Physical layer module 6090 may determine which fields of the preamble to fill in. In some examples, the physical layer module 6090 may fill in only the non STA specific fields in the VHT-SIG-A (e.g., not fill in the STA specific fields). In other examples, the physical layer module 6090 may not fill in any of the fields in the VHT-SIG-A. In still other examples, the physical layer module 6090 may not include one or more of the L-STF, L-LTF, L-SIG, and VHT-SIG-A fields. In some examples, the STA specific transmission parameters, the common transmission parameters, or both may be added to the frame after the VHT-LTF and VHT-STF—for example, in the VHT-SIG-B field.

Transmission and reception module 6080 may modulate packets on the wireless medium sent from the STA 6060 and may demodulate packets sent from the AP 6010. In some examples the modulation and demodulation may be based upon the transmission parameters sent by the AP 6010 through first protocol layer module 6070.

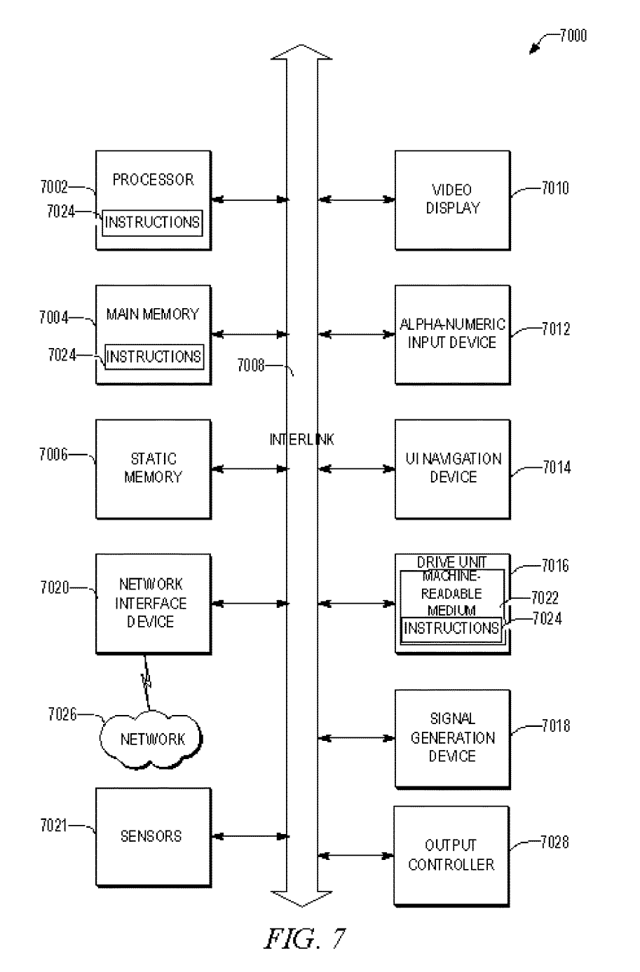

FIG. 7 illustrates a block diagram of an example machine 7000 upon which any one or more of the techniques (e.g., methodologies) discussed herein may perform. In some examples, the AP and STA of FIG. 6 may be or include one or more of the components of FIG. 7. For example, one or more components in FIG. 7 may be configured to implement one or more of the components of FIG. 6. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be a AP, STA, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The Machine 7000 may communicate with one or more other machines using one or more networks. Machine 7000 may utilize any one or more of a number of communication and network protocols implemented in some examples by one or more of the components of machine 7000 including the network interface device 7020. Examples include a frame relay, internet protocol (IP), transmission control protocol (TCP), user datagram protocol (UDP), hypertext transfer protocol (HTTP), protocols relating to local area networks (LAN), wide area networks (WAN), packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISO) techniques. In some examples, the network interface device 7020 and/or other components of machine 7000 may wirelessly communicate using Multiple User MIMO techniques. Network interface device 7020 and/or other components of machine 7000 may modulate and demodulate packets utilizing Orthogonal Frequency Division Multiplexing (OFDM) techniques and may implement one or more network protocol layers such as a Medium Access Control layer (MAC layer) a Physical Layer (PHY) and the like.

### Other Notes and Examples

Example 1 includes subject matter (such as a method, means for performing acts, machine readable medium including instructions) for sending an Uplink Multiple User Multiple Input Multiple Output (UL-MU-MIMO) packet comprising receiving station (STA) specific UL MU-MIMO transmission parameters in a protocol message of a protocol that is of a higher layer than a physical layer; receiving an medium access control protocol data unit (MPDU) for transmission; generating a physical layer convergence protocol data unit (PPDU) based upon the STA specific UL MU-MIMO transmission parameters and the MPDU; and sending the PPDU utilizing the STA specific UL MU-MIMO transmission parameters.

In example 2, the subject matter of example 1 may optionally include wherein the PPDU includes a Very High Throughput Signal A (VHT-SIG A) field which does not include the STA specific UL MU-MIMO transmission parameters.

In example 3, the subject matter of any one or more of examples 1-2 may optionally include receiving general UL MU-MIMO transmission parameters that are not specific to a particular STA in the protocol message, wherein the general UL MU-MIMO transmission parameters provide the same transmission parameters to a plurality of stations that are arranged for the UL-MU-MIMO transmissions.

In example 4, the subject matter of any one or more of examples 1-3 may optionally include wherein the protocol message is a Medium Access Control (MAC) protocol.

In example 5, the subject matter of any one or more of examples 1-4 may optionally include wherein the STA specific parameters includes one or more of: modulation and coding scheme information (MCS), a length of a data field, a coding type, and spatial stream information.

In example 6, the subject matter of any one or more of examples 1-5 may optionally include wherein the PPDU excludes at least one of the Legacy Short Training Field, Legacy Long Training Field, Legacy Signal, and Very High Throughput Signal A fields.

Example 7 includes or may optionally be combined with the subject matter of any one of examples 1-6 to include subject matter (such as a device, apparatus, or machine) comprising a first protocol layer module configured to receive STA specific Uplink Multiple User Multiple Input Multiple Output (UL MU-MIMO) transmission parameters in a protocol message of a protocol that is of a higher layer than a physical layer; a physical layer module configured to: receive an medium access control protocol data unit (MPDU) for transmission; and generate a physical layer convergence protocol data unit (PPDU) based upon the STA specific UL MU-MIMO transmission parameters and the MPDU; and a transmission and reception module configured to: send the PPDU utilizing the STA specific UL MU-MIMO transmission parameters.

In example 8, the subject matter of any one or more of examples 1-7 may optionally include wherein the PPDU includes a Very High Throughput Signal A (VHT-SIG A) field which does not include the STA specific UL MU-MIMO transmission parameters.

In example 9, the subject matter of any one or more of examples 1-8 may optionally include wherein the first protocol layer module is configured to receive general UL MU-MIMO transmission parameters that are not specific to a particular STA in the protocol message, wherein the general UL MU-MIMO transmission parameters provide the same transmission parameters to a plurality of stations that are arranged for the UL-MU-MIMO transmissions.

In example 10, the subject matter of any one or more of examples 1-9 may optionally include wherein the protocol message is a Medium Access Control (MAC) protocol.

In example 11, the subject matter of any one or more of examples 1-10 may optionally include wherein the STA specific parameters includes one or more of: modulation and coding scheme information (MCS), a length of a data field, a coding type, and spatial stream information.

In example 12, the subject matter of any one or more of examples 1-11 may optionally include wherein the PPDU excludes at least one of the Legacy Short Training Field, Legacy Long Training Field, Legacy Signal, and Very High Throughput Signal A fields.

Example 13 includes or may optionally be combined with the subject matter of any one of examples 1-12 to include subject matter (such as a method, means for performing acts, machine readable medium including instructions for performing operations) comprising transmitting to a plurality of stations (STA) STA specific UL MU-MIMO transmission parameters in a protocol message of a protocol that is of a higher layer than a physical layer; receiving a plurality of PPDUs from the plurality of STA by utilizing the transmitted STA specific UL MU-MIMO transmission parameters and ignoring any STA specific parameters in a preamble field of the PPDUs that is prior to a MU-MIMO training field.

In example 14, the subject matter of any one or more of examples 1-13 may optionally include wherein the preamble field is a Very High Throughput Signal A field.

In example 15, the subject matter of any one or more of examples 1-14 may optionally include wherein the MU-MIMO training field is one of a Very High Throughput Short Training Field, Very High Throughput Long Training Field.

In example 16, the subject matter of any one or more of examples 1-15 may optionally include wherein the protocol message is a Medium Access Control (MAC) protocol message.

Example 17 includes or may optionally be combined with the subject matter of any one of Examples 1-16 to include subject matter (such as a device, apparatus, or machine) comprising a transmission and reception module configured to: transmit to a plurality of stations (STA) STA specific UL MU-MIMO transmission parameters in a protocol message of a protocol that is of a higher layer than a physical layer; and receive a plurality of PPDUs from the plurality of STA; a physical layer module configured to: decode the plurality of PPDUs from the plurality of STA by utilizing the transmitted STA specific UL MU-MIMO transmission parameters and ignoring any STA specific parameters in a preamble field of the PPDUs that is prior to a MU-MIMO training field.

In example 18, the subject matter of any one or more of examples 1-17 may optionally include wherein the preamble field is a Very High Throughput Signal A field.

In example 19, the subject matter of any one or more of examples 1-18 may optionally include wherein the MU-MIMO training field is one of a Very High Throughput Short Training Field, Very High Throughput Long Training Field.

In example 20, the subject matter of any one or more of examples 1-19 may optionally include wherein the protocol message is a Medium Access Control (MAC) protocol message.

1-22. (canceled)

23. A wireless station (STA) comprising:
a first protocol layer module configured to:
receive STA specific Uplink Multiple User Multiple Input Multiple Output (UL MU-MIMO) transmission parameters in a protocol message of a protocol that is of a higher layer than a physical layer;
a physical layer module configured to:
receive an medium access control protocol data unit (MPDU) for transmission; and
generate a physical layer convergence protocol data unit (PPDU) based upon the STA specific UL MU-MIMO transmission parameters and the MPDU; and
a transmission and reception module configured to:
send the PPDU utilizing the STA specific UL MU-MIMO transmission parameters.

24. The STA of claim 23, wherein the PPDU includes a Very High Throughput Signal A (VHT-SIG A) field which does not include the STA specific UL MU-MIMO transmission parameters.

25. The STA of claim 23, wherein the first protocol layer module is configured to receive general UL MU-MIMO transmission parameters that are not specific to a particular STA in the protocol message, wherein the general UL MU-MIMO transmission parameters provide the same transmission parameters to a plurality of stations that are arranged for the UL-MU-MIMO transmissions.

26. The STA of claim 23, wherein the protocol message is a Medium Access Control (MAC) protocol.

27. The STA of claim 23, wherein the STA specific parameters includes one or more of: modulation and coding scheme information (MCS), a length of a data field, a coding type, and spatial stream information.

28. The STA of claim 23, wherein the PPDU excludes at least one of the Legacy Short Training Field, Legacy Long Training Field, Legacy Signal, and Very High Throughput Signal A fields.

29. A non-transitory machine readable medium that stores instructions, which when performed by a machine, cause the machine to perform operations comprising:
receiving station (STA) specific Uplink Multiple User Multiple Input Multiple Output (UL MU-MIMO) transmission parameters in a protocol message of a protocol that is of a higher layer than a physical layer;
receiving an medium access control protocol data unit (MPDU) for transmission;
generating a physical layer convergence protocol data unit (PPDU) based upon the STA specific UL MU-MIMO transmission parameters and the MPDU; and
sending the PPDU utilizing the STA specific UL MU-MIMO transmission parameters.

30. The machine readable medium of claim 29, wherein the PPDU includes a Very High Throughput Signal A (VHT-SIG A) field which does not include the STA specific UL MU-MIMO transmission parameters.

31. The machine readable medium of claim 29, wherein the operations comprise:
receiving general UL MU-MIMO transmission parameters that are not specific to a particular STA in the protocol message, wherein the general UL MU-MIMO transmission parameters provide the same transmission parameters to a plurality of stations that are arranged for the UL-MU-MIMO transmissions.

32. The machine readable medium of claim 29, wherein the protocol message is a Medium Access Control (MAC) protocol.

33. The machine readable medium of claim 29, wherein the STA specific parameters includes one or more of: modulation and coding scheme information (MCS), a length of a data field, a coding type, and spatial stream information.

34. The machine readable medium of claim 29, wherein the PPDU excludes at least one of the Legacy Short Training Field, Legacy Long Training Field, Legacy Signal, and Very High Throughput Signal A fields.

35. An Access Point (AP) comprising:
a transmission and reception module configured to:
transmit to a plurality of stations (STA) STA specific UL MU-MIMO transmission parameters in a protocol message of a protocol that is of a higher layer than a physical layer; and
receive a plurality of PPDUs from the plurality of STA;
a physical layer module configured to:
decode the plurality of PPDUs from the plurality of STA by utilizing the transmitted STA specific UL MU-MIMO transmission parameters and ignoring any STA specific parameters in a preamble field of the PPDUs that is prior to a MU-MIMO training field.

36. The AP of claim 35, wherein the preamble field is a Very High Throughput Signal A field.

37. The AP of claim 35, wherein the MU-MIMO training field is one of a Very High Throughput Short Training Field, Very High Throughput Long Training Field.

38. The AP of claim 35, wherein the protocol message is a Medium Access Control (MAC) protocol message.

39. A non-transitory machine readable medium that stores instructions, which when performed by a machine, cause the machine to perform operations comprising:
transmitting to a plurality of stations (STA) STA specific UL MU-MIMO transmission parameters in a protocol message of a protocol that is of a higher layer than a physical layer;
receiving a plurality of PPDUs from the plurality of STA by utilizing the transmitted STA specific UL MU-MIMO transmission parameters and ignoring any STA specific parameters in a preamble field of the PPDUs that is prior to a MU-MIMO training field.

40. The machine readable medium of claim 39, wherein the preamble field is a Very High Throughput Signal A field.

41. The machine readable medium of claim 39, wherein the MU-MIMO training field is one of a Very High Throughput Short Training Field, Very High Throughput Long Training Field.

42. The machine readable medium of claim 39, wherein the protocol message is a Medium Access Control (MAC) protocol message.
